(19) United States
(12) Patent Application Publication
(10) Pub. No.: US 2012/0082209 A1
(43) Pub. Date: Apr. 5, 2012

(54) METHOD AND APPARATUS FOR DYNAMICALLY ADJUSTING VIDEO QUALITY

(76) Inventors: Ruijia Li, Shanghai (CN); Xuquan Ji, Shanghai (CN); Jie Yang, Shanghai (CN)

(21) Appl. No.: 12/993,120

(22) PCT Filed: Oct. 5, 2010
(86) PCT No.: PCT/CN2010/001549

§ 371 Date: Jan. 27, 2011

(51) Int. Cl. H04N 7/26

(52) U.S. Cl. 375/240.02; 375/E07.126

(57) ABSTRACT

A system, apparatus, method and article for dynamic adjustment of video quality are described. The apparatus may include a power status module to receive power status information for a communication device, and a video quality adjustment module to adjust at least one aspect of video data captured by the device based on power status of the device. The power status can include information regarding the battery power level of the device. The adjusted aspect of video data can be an encoding aspect of the video data. The adjusted aspect of video data can be a quantization level and/or a motion estimation range of said video data. Other embodiments are described and claimed.

### BACKGROUND

Utilizing wireless connectivity as a means for communicating between computing devices is becoming increasingly popular. Video communication connections can be established between computing devices to enhance the person-to-person communication experience. Such video communications often require substantial processing power, however. For small mobile communications devices with limited battery capacities this can mean that video communications can only be supported for a short time before battery depletion requires at least the video portion of the communication to be discontinued. Consequently, there exists a substantial need for a method and apparatus for enhancing mobile device video communications by extending the period during which video communications can take place before the device's battery is depleted.

### BRIEF DESCRIPTION OF THE DRAWINGS

FIG. 1 illustrates one embodiment of a system.

FIG. 2 illustrates one embodiment of a computing device.

FIG. 3 illustrates one embodiment of a logic diagram.

FIG. 4 illustrates another embodiment of a system

### DETAILED DESCRIPTION

The embodiments may generally relate to a method and apparatus for adjusting video quality on a mobile communication device depending upon the power status of the device. One embodiment relates to a mobile computing device comprising a video quality adjustment module for adjusting one or more aspects of captured video data depending upon a power status of the device. In some embodiments, the video quality aspect adjustment is a quantization aspect of the video data. In other embodiments, the video quality aspect adjustment is a motion estimation aspect of the video data. A further embodiment relates to a method for performing video quality adjustment based on a power status of a mobile communication device. Other embodiments are described and claimed.

Users of computing devices with wireless communication capabilities, hereinafter referred to as mobile computing devices, may desire to wirelessly connect to other mobile computing devices to engage in real-time, two-way, video and audio communication.

During video communication, each side captures an image of the speaker, encodes it, and transmits it through a network, for example a 3G network. Such usage, however, is power intensive and requires several components (e.g., camera, processor and network) to work together. This consumes battery power at a high rate and reduces the usage time for the involved mobile devices.

One of the power consuming portions of the video communication process is encoding, in which captured images are encoded (e.g., compressed) to an appropriate format, for example, H264. Since encoding requires compression in real time, it is computation intensive and thus consumes substantial power. As a result, when a user device is in a relatively low power status, it may not be possible for the user to continue video communication. Some existing approaches include stopping the video portion of the communication and continuing with voice only. Other approaches reduce the image size, or refresh the image at a lower frequency. Each of these prior solutions can be problematic because they negatively impact the user experience.

Therefore, in various embodiments, a method and apparatus for dynamically adjusting video quality of a two-way video communication are described that change aspects of video communication based on changes in the power status of the affected mobile device. Other embodiments are described and claimed.

Numerous specific details are set forth to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

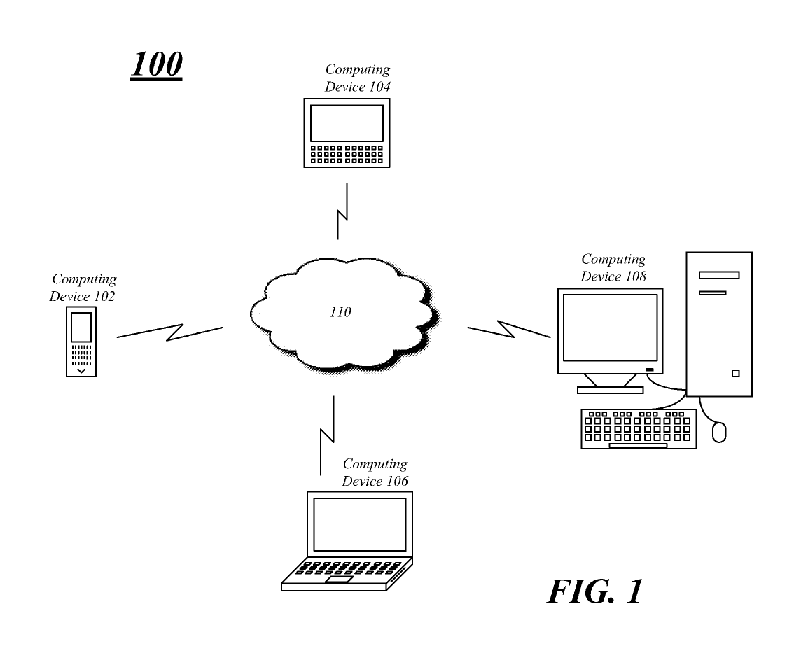

FIG. 1 illustrates one embodiment of a system 100. System 100 may be representative of the one or more embodiments described herein. System 100 includes computing devices 102, 104, 106 and 108 and network 110. Network 110 may comprise any wireless communication network suitable for wirelessly communicating information. The computing devices 102, 104, 106 and 108 may comprise any computing device capable of wireless communication. For example, computing device 102 may comprise a smart-phone, computing device 104 may comprise a mobile internet device (MID), computing device 106 may comprise a laptop computer and computing device 108 may comprise a desktop computer. Although FIG. 1 may show a limited number of computing devices by way of example, it will be appreciated that a greater or a fewer number of devices may be employed for a given implementation.

In various embodiments, it may be desirable to establish a wireless connection between two or more of the computing devices 102, 104, 106 or 108. For example, computing device 102 may be wirelessly connected to any one or more of the computing devices 104, 106 or 108 to engage in two-way video communication between device users.

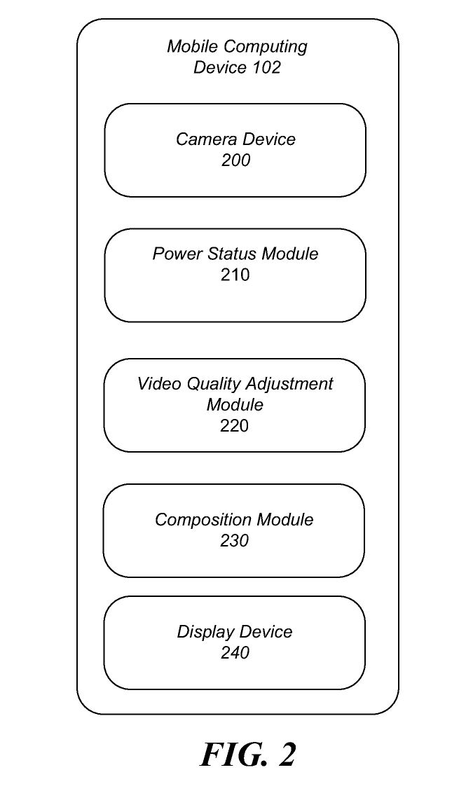

Referring to FIG. 2, the computing device 102 may include a camera device 200 for capturing video data to be saved and/or transmitted one or more other computing devices 104, 106, 108. Although the description will proceed with regard to device 102, it will be appreciated that the description may apply equally to one or more of the computing devices 104, 106 and 108.

The computing device 102 may further include a power status module 210 for periodically receiving power status information relating to the device. This power status information may include information regarding whether the device is connected to external power, and/or information regarding a power level of a battery associated with the computing device 102.

The computing device 102 may further include a video quality adjustment module 220 for receiving power status information from the power status module 210 and for adjusting the quality of video captured by the camera device 200 based on the received power status. In one embodiment, the captured video quality is adjusted by adjusting one or more encoding aspects of the video data captured by the camera device 200. In another embodiment, encoding is adjusted by adjusting an encoding quantization value. In yet another embodiment, encoding is adjusted by adjusting an encoding motion estimation value.

In general, the video quality adjustment module 220 adjusts the quality of the captured video depending upon the power level of the battery, as indicated by the power status module 210. This quality adjustment may be performed in a dynamic manner so as to track changes in the power status of the computing device 102. Such dynamic adjustment may extend the video usage duration of the device 102 by maintaining video quality at a reduced, and acceptable, quality as battery power is depleted during device operation.

As will be described in greater detail later, the computing device 102 may also include a composition module 230 for providing a user with graphical display information regarding battery power and/or video quality.

As noted, quality of an image may be adjusted by adjusting the encoding of the associated video data. Lower output video quality may be associated with reduced data computation, which, in turn, requires less power. In some embodiments, encoding is adjusted by reducing the range of motion estimation between successive video frames to decrease search computation, reducing the amount of data present for variable-length encoding after high quantization to increase the number of skipped macroblocks.

By adopting a power-status based encoding scheme, video communication time may be extended, even during relatively low power operation of the device 102. This may be an advantage over prior systems that simply shut off the video portion of the communication once a low power level has been reached.

In an embodiment, discrete video quality levels may be associated with discrete power levels of the device 102. Thus, in one non-limiting embodiment, a “high” quality video level may be associated with battery power levels of 80% and greater, as well as instances in which the device 102 is connected to external power. A “medium” quality video level may be associated with battery power levels of from 20% to 80%, and a “low” quality video level may be associated with battery power levels of less than 20%.

As such, where the power status module 210 determines that the device 102 is connected to external power, or if the battery power level is determined to be 80% or greater, the video quality adjustment module 220 may apply a set of high quality encoding aspects to video data captured by the device 102. Likewise, where the battery power level is determined to be from 20% to 80%, the video quality adjustment module 220 may apply a set of normal quality encoding aspects to captured video data, and where the battery power level is determined to be less than 20%, a set of low quality encoding aspects may be applied. Such encoding aspects may include motion estimation aspects and quantization aspects.

As part of the encoding process, a rectangular block of pixel data may be subtracted from a reference block in a previous frame, and the resulting difference information may be transformed to produce co-efficient data. The coefficient data is quantized, and the resulting information is then reordered and entropy encoded for transmission.

Motion estimation is often employed to take advantage of temporal redundancies in a video signal when there is motion and/or camera movement in the picture. A reference block may be displaced in the image frame from the block which is currently being coded. The displacement of the reference block is often referred to as “motion compensation.” “Motion estimation” determines which pixel block in the previous frame (within a search window) best matches the pixel block which is currently being coded. The displacement between the currently-coded block and the best matching block in the previous frame is indicated by a “motion vector,” which specifies the location of a macroblock within a current picture relative to its original location within an anchor picture, based upon a comparison between the pixels of the current macroblock and corresponding array of pixels in the anchor picture within a given N×N-pixel search range.

It will be appreciated that using a relatively large search range may require increased processing power due to the larger number of pixels that must be searched. Similarly, reducing the search range (i.e., the number of pixels) for finding a matching block may reduce computation time, and thus reduces the amount of battery power required to perform the search. For example, if the motion estimation search range is set as a single macroblock measuring 16×16 pixels, a total of 256 pixels may be searched. By contrast, if the motion estimation search range is set as only a portion of a macroblock, for example, 8×8 pixels, a total of only 64 pixels may be searched, thus reducing the processing time for finding a “matching” pixel by 75% as compared to the 16×16 pixel search range.

Thus, in one embodiment, non-limiting exemplary values of a motion estimation search range for “high” quality video may be 20×20 pixels, or 32×32 pixels. Non-limiting exemplary values of a motion estimation search range for “normal” quality video may be 16×16 pixels. Non-limiting exemplary values of motion estimation search range for “low” quality video may be 8×8 pixels, or 4×4 pixels. It will be appreciated that these quality designation and representative search ranges are merely exemplary, and that any of a variety of other search ranges may be specified.

Another technique often used in encoding video data is referred to as quantization. Quantization, in general, is used to compress a range of values to a single quantum value. When the number of discrete values in a given data stream is reduced, the data stream becomes more compressible. For example, reducing the number of colors required to represent a digital image makes it possible to reduce its file size.

During the encoding process, a macroblock of pixels may be transformed using a 4×4 or 8×8 integer transform, which in one non-limiting embodiment is a form of the Discrete Cosine Transform (DCT). The transform may output a set of coefficients, each of which may be a weighting value for a standard basis pattern. When combined, the weighted basis patterns re-create the macroblock of pixels.

The output of the transform, which may be a block of transform coefficients, is quantized (e.g. each coefficient is divided by an integer value). Quantization thus may reduce the precision of the transform coefficients according to a quantization parameter. Often, the result is a block in which most or all of the coefficients are zero, with a few non-zero coefficients. Setting the quantization parameter to a high value may result in more of the transform coefficients being set to zero, which may result in high compression at the expense of relatively poorer decoded image quality. By contrast, setting the quantization parameter to a low value may result in more of the transform coefficients being non-zero after quantization, resulting in better decoded image quality but lower compression.

As will be appreciated, increasing the quantization parameter in the encoding process may reduce computation time, and thus reduces the overall amount of battery power required to perform the encoding computations. By contrast, decreasing the quantization parameter may increase computation time, thus increasing the load on the battery.

Thus, in one embodiment, exemplary non-limiting values of quantization parameter for “high” quality video may be in a range of from 4-5. A non-limiting exemplary value of quantization parameter for “normal” quality video may be about 15. A non-limiting exemplary of quantization parameter for “low” quality video may be about 25-30. It will be appreciated that these quality designation and representative quantization parameter values and ranges are merely exemplary, and that any of a variety of other search designations, values and ranges may be specified.

It will be appreciated that the specific values of motion estimation and quantization parameter may depend upon the particular video format implemented by the device 102. Exemplary values have been provided for the H264 format. It will be appreciated, however, that for other video formats (e.g., MPEG2, MPEG4) different motion estimation and quantization parameters may be used.

It will also be appreciated that other motion estimation and quantization values and/or ranges may be implemented as desired. Furthermore, although three discrete quality levels have been described, greater or fewer quality levels may be implemented, as desired.

One or more values of motion estimation and quantization associated with “high,” “normal” or “low” quality may be predefined by the device's configuration file. In addition, or alternatively, these values may be defined or adjusted by the user. For example, in one embodiment the device's configuration file may contain certain preset quality levels which the user can then accept or modify as desired.

In addition, it will be appreciated that other video quality may also be modified using techniques other than, or in addition to, modifying encoding aspects such as motion estimation and quantization parameters. Other techniques, such as switching video encoders and switching communication links, may also be used to adjust displayed video quality. Further, switching video transmission bit rates may result in a desired change in video quality. In one embodiment, a video transmission application may operate at a variety of bit rates. At high bit rates, a temporal distance between adjacent pictures may be smaller, and thus, a smaller search range may be used to achieve a given image quality. At low bit rates, the situation may be reversed, and a larger search range may be required in order to attain a desired image quality.

As previously noted, the power status module 210 may provide device power information to the video quality adjustment module 220 which then may adjust video quality based on that power information. In some embodiments, the power status module 210 may determine that the device 102 is connected to an external source of power. In such an instance, the video quality adjustment module 220 may apply the highest quality encoding settings to video data received by the device 102. Such settings may remain until the device is uncoupled from the external power source, whereupon the device's operating system may indicate that a power change has occurred.

If the power status module 210 determines that an external source of power is not connected (or no longer connected), then the device API may check the device's power status and provide device power information to the power status module 210 on a periodic basis. In one non-limiting embodiment, this period may be once every second. In another embodiment, the periodicity of this check of the device's power status may be preset. In a further embodiment, the periodicity may be defined by the user.

Although embodiments have been disclosed with exemplary ranges for encoding aspects of motion estimation and quantization based on “high,” “normal” and “low” video quality designations, it will be appreciated that these are merely examples provided for purposes of explanation. As such, it is contemplated that any of a variety of quality classifications and/or designations can be used.

It is also contemplated that some embodiments may include video quality classifications in which only a quantization aspect is changed, or in which only a motion estimation aspect are adjusted. In addition, other video quality classification schemes may be employed in which certain quality classifications involve adjusting both motion estimation and quantization aspects, while certain other quality classifications involve adjusting only the motion estimation aspect or only the quantization aspect. Further permutations of classifications and encoding aspect adjustments are also contemplated.

As previously noted, some embodiments of the computing device 102 may include a composition module 230 to generate a graphical user interface which may include graphical icons, graphs, or text, organized to represent the device's power status information and/or video quality information. In various embodiments, the icons may include graphical representations of the device's power status information, received from the power status module 210, as well as the device's video quality information, received from the video quality adjustment module 220.

The graphical user interface may be employed by a user to select, adjust, and/or override pre-determined video quality settings for the device 102.

The computing device 102 may also have a display device 240 for displaying video received from one or more other computing devices 104, 106, 108. In some embodiments, the display device may be a digital electronic display, a vacuum fluorescent (VF) display, a light emitting diode (LED) display, a plasma display (PDP), a liquid crystal display (LCD), a high performance addressing (HPA) display, a thin-film transistor (TFT) display, an organic IED (OLED) display, a heads-up display (HUD), etc.

As previously noted, the computing device 102 may include a camera device 200 for capturing video data to be encoded and saved or transmitted to one or more other computing devices 104, 106, 108. In some embodiments, the camera device 200 may be a digital video camera. In one non-limiting embodiment, the camera device may be a high definition digital video camera. In some embodiments, the camera device 200 may be embedded in the computing device 102 (e.g., cell phone), while in other embodiments the camera device 200 may be connected to the computing device 102 (e.g., web cam).

In various embodiments, each mobile computing device may include various physical and/or logical components for communicating information which may be implemented as hardware components (e.g., computing devices, processors, logic devices), executable computer program instructions (e.g., firmware, software) to be executed by various hardware components, or any combination thereof, as desired for a given set of design parameters or performance constraints. Exemplary mobile computing devices with which connections may be established include a personal computer (PC), desktop PC, notebook PC, laptop computer, mobile computing device, smart phone, personal digital assistant (PDA), mobile telephone, mobile internet device (MID), combination mobile telephone/PDA, video device, television (TV) device, digital TV (DTV) device, high-definition TV (HDTV) device, media player device, gaming device, messaging device, or any other suitable communications device in accordance with the described embodiments.

The mobile computing devices may form part of a wired communications system, a wireless communications system, or a combination of both. For example, the mobile computing devices may be arranged to communicate information over one or more types of wired communication links such as a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The mobile computing devices may be arranged to communicate information over one or more types of wireless communication links such as a radio channel, satellite channel, television channel, broadcast channel infrared channel, radio-frequency (RF) channel, Wireless Fidelity (WiFi) channel, a portion of the RF spectrum, and/or one or more licensed or license-free frequency bands. In wireless implementations, the mobile computing devices may comprise one more interfaces and/or components for wireless communication such as one or more transmitters, receivers, transceivers, amplifiers, filters, control logic, wireless network interface cards (WNICs), antennas, and so forth. Although certain embodiments may be illustrated using a particular communications media by way of example, it may be appreciated that the described embodiments may be implemented using various communication media and accompanying technology.

Examples of systems and devices in which embodiments described herein can be incorporated comprise wireless local area network (WLAN) systems, wireless metropolitan area network (WMAN) systems, wireless personal area networks (WPAN), wide area networks (WAN), cellular telephone systems, radio networks, computers, and wireless communication devices, among others. Those skilled in the art will appreciate, based on the description provided herein, that the embodiments may be used in other systems and/or devices.

Embodiments of systems and devices described herein may comply or operate in accordance with a multitude of wireless standards. For example, a system and associated nodes may comply or communicate in accordance with one or more wireless protocols, which may be defined by one or more protocol standards as promulgated by a standards organization, such as the Internet Engineering Task Force (IETF), International Telecommunications Union (ITU), the Institute of Electrical and Electronics Engineers (IEEE), and so forth. In the context of a WLAN system, the nodes may comply or communicate in accordance with various protocols, such as the IEEE 802.11 series of protocols (e.g., wireless fidelity or WiFi). In the context of a WMAN system, the nodes may comply or communicate in accordance with the IEEE 802.16 series of protocols such as the Worldwide Interoperability for Microwave Access (WiMAX), for example. Those skilled in the art will appreciate that WiMAX is a standards-based wireless technology to provide high-throughput broadband connections over long distances (long range). WiMAX can be used for a number of applications, including “last mile” wireless broadband connections, hotspots, cellular backhaul, and high-speed enterprise connectivity for business. In the context of a personal area network (PAN), the nodes may comply or communicate in accordance with the IEEE 802.15 series of protocols otherwise known as Bluetooth, for example. In the context of a MAN, the nodes may comply or communicate in accordance with the IEEE 802.20 series of protocols, for example. For mobility across multiple networks, the nodes may comply or communicate in accordance with the IEEE 802.21 series of protocols, for example. In other embodiments, the system and nodes may comply with or operate in accordance with various WMAN mobile broadband wireless access (MBWA) systems, protocols, and standards, for example. The embodiments, however, are not limited in this context.

Embodiments of systems and devices described herein may comply or operate in accordance with a multitude of wireless technologies and access standards. Examples of wireless technologies and standards may comprise cellular networks (e.g., Global System for Mobile communications or GSM), Universal Mobile Telecommunications System (UTS), High-Speed Downlink Packet Access (HSDPA), Broadband Radio Access Networks (BRAN), General Packet Radio Service (GPRS), 3.sup.rd Generation Partnership Project (3GPP), and Global Positioning System (GPS); and Ultra Wide Band (UWB), Code Division Multiple Access (CDMA), CDMA 2000, Wideband Code-Division Multiple Access (W-CDMA), Enhanced General Packet Radio Service (EGPRS), among others. Systems and devices in accordance with various embodiments may be arranged to support multiple heterogeneous wireless devices to communicate over these wireless communication networks. The embodiments, however, are not limited in this context.

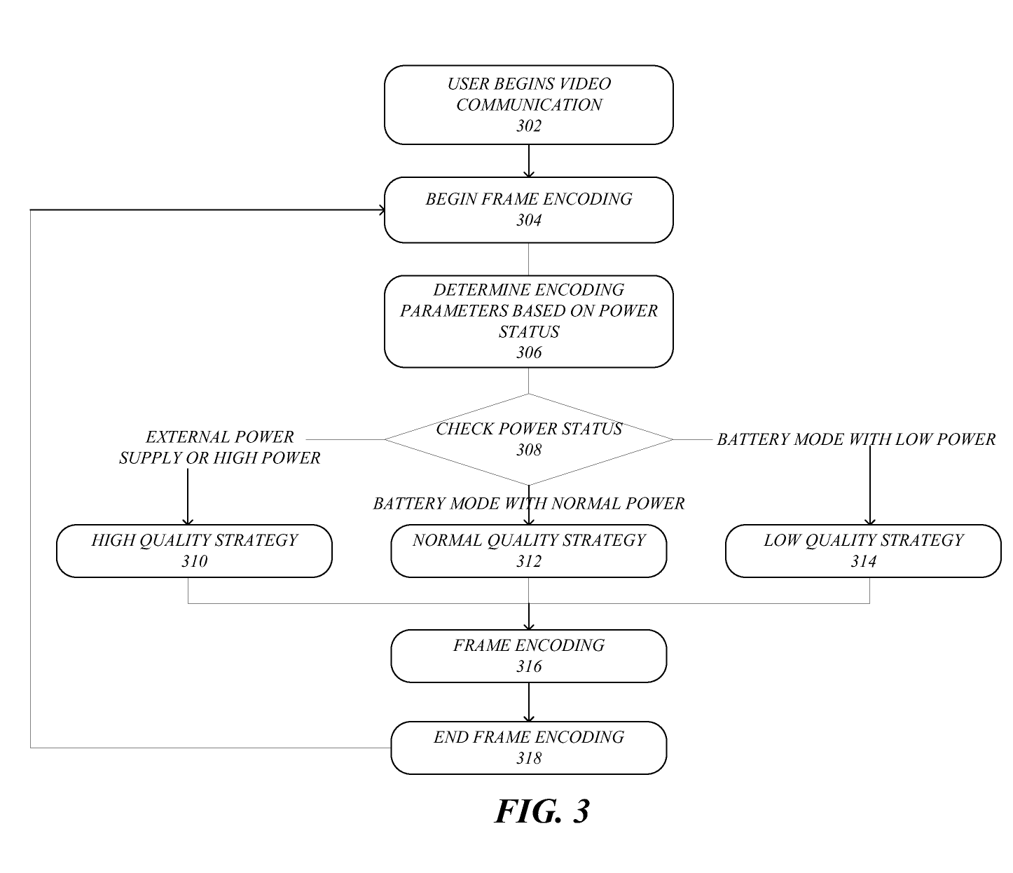

FIG. 3 illustrates one embodiment of a logic flow 300. Logic flow 300 may be representative of the operations executed by one or more embodiments described herein. As shown in logic flow 300, at 302 a user may begin video communication, for example, using computing device 102, communicating with one or more other computing devices 104, 106, 108.

At 304, frame encoding of video data begins. At 306, encoding parameters, including a motion estimation value and a quantization value, are determined based on a power status of the device 102. This determination proceeds, at 308, where the power status of the device is determined using, for example, the power status module 210. If the power status module 210 determines that the device is connected to external power, or that the device's battery is in a high power configuration (e.g., 80% or more power remaining), then at 310 a high quality encoding strategy is selected. If the power status module 210 determines that the device is not connected to external power and that the battery is in a normal power configuration (e.g., 20% to 80% power remaining), then at 312 a normal quality encoding strategy is selected. If the power status module 210 determines that the device is not connected to external power and that the battery is in a low power configuration (e.g., less than 20% power remaining), then at 314a low quality encoding strategy is selected. At 316 frame encoding proceeds using the selected encoding strategy. At 318, frame encoding ends, and the process returns to 304.

Icons or the graphical representations of the power status information and video quality information may be dynamically changed within the graphical user interface in response to changes in the battery power and/or video quality.

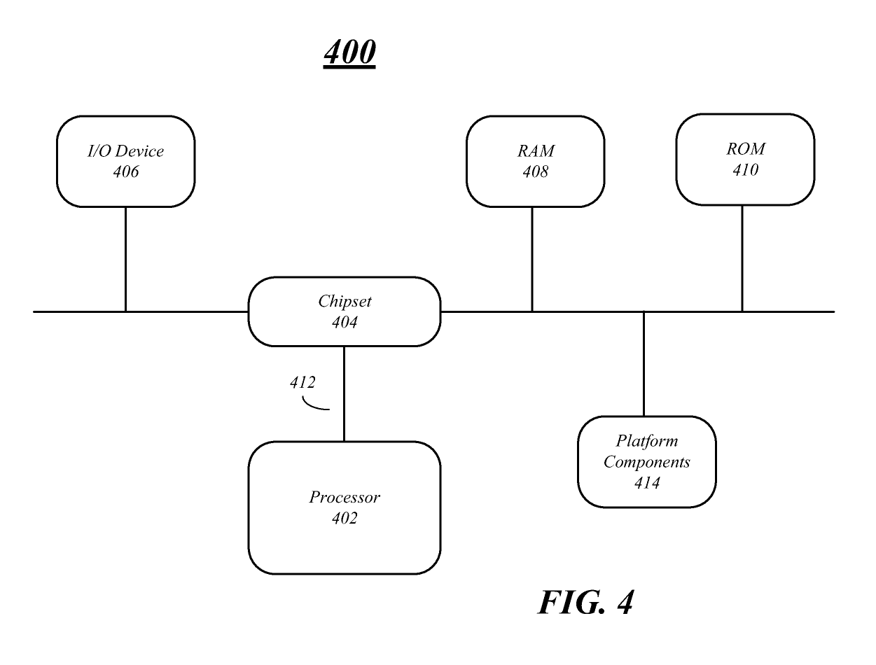

FIG. 4 is a diagram of an exemplary system embodiment. In particular, FIG. 4 is a diagram showing a system 400, which may include various elements and may represent any of the above described mobile computing devices, for example. For instance, FIG. 4 shows that system 400 may include a processor 402, a chipset 404, an input/output (I/O) device 406, a random access memory (RAM) (such as dynamic RAM (DRAM)) 408, and a read only memory (ROM) 410, and various platform components 414 (e.g., a heat sink, DTM system, cooling system, housing, vents, and so forth). These elements may be implemented in hardware, software, firmware, or any combination thereof. The embodiments, however, are not limited to these elements.

In particular, the platform components 414 may include a cooling system implementing various DTM techniques. The cooling system may be sized for the system 400, and may include any cooling elements designed to perform heat dissipation, such as heat pipes, heat links, heat transfers, heat spreaders, vents, fans, blowers, and liquid-based coolants.

As shown in FIG. 4, I/O device 406, RAM 408, and ROM 410 are coupled to processor 402 by way of chipset 404. Chipset 404 may be coupled to processor 402 by a bus 412. Accordingly, bus 412 may include multiple lines.

Processor 402 may be a central processing unit comprising one or more processor cores (102-1-m). The processor 402 may include any type of processing unit, such as, for example, CPU, multi-processing unit, a reduced instruction set computer (RISC), a processor that have a pipeline, a complex instruction set computer (CISC), digital signal processor (DSP), and so forth.

Processor 402 may operate at different performance levels. Accordingly, processor 402 may enter into various operational states, such as one or more active mode P-states. Thus, processor 402 may include features described above with reference to FIGS. 1-3. For instance, processor 402 may include the elements of any of the above described mobile computing devices, among others.

Although not shown, the system 400 may include various interface circuits, such as an Ethernet interface and/or a Universal Serial Bus (USB) interface, and/or the like. In some exemplary embodiments, the I/O device 406 may comprise one or more input devices connected to interface circuits for entering data and commands into the system 400. For example, the input devices may include a keyboard, mouse, touch screen, track pad, track ball, isopoint, a voice recognition system, camera, microphone, touchscreen display, biometric device and/or the like. Similarly, the I/O device 406 may comprise one or more output devices connected to the interface circuits for outputting information to an operator. For example, the output devices may include one or more displays, printers, speakers, and/or other output devices, if desired. For example, one of the output devices may be a display. The display may be a cathode ray tube (CRTs), liquid crystal displays (LCDs), or any other type of display.

The system 400 may also have a wired or wireless network interface to exchange data with other devices via a connection to a network. The network connection may be any type of network connection, such as an Ethernet connection, digital subscriber line (DSL), telephone line, coaxial cable, etc. The network may be any type of network, such as the Internet, a telephone network, a cable network, a wireless network, a packet-switched network, a circuit-switched network, and/or the like.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a storage medium, a computer-readable medium or an article of manufacture which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory (including non-transitory memory), removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

It should be understood that embodiments may be used in a variety of applications. Although the embodiments are not limited in this respect, certain embodiments may be used in conjunction with many electronic devices, such as a personal computer, a desktop computer, a mobile computer, a laptop computer, a notebook computer, a tablet computer, a server computer, a network, a Personal Digital Assistant (PDA) device, a wireless communication station, a wireless communication device, a cellular telephone, a mobile telephone, a wireless telephone, a PDA device or the like.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a power status module to identify power status information for a device, and
a video quality adjustment module to adjust an encoding aspect of video data based on said identified power status information.

2. The apparatus of claim 1, wherein said power status information includes information regarding a power level of a battery of said device.

3. The apparatus of claim 1, wherein said power status module is configured to identify power status information for said device at a predetermined rate.

4. The apparatus of claim 1, wherein said power status module is configured to identify power status information of said device at a user-selectable rate.

5. The apparatus of claim 1, wherein said video quality adjustment module is configured to adjust a plurality of encoding aspects of said video data based on a user selection of a video quality level.

6. The apparatus of claim 1, said apparatus comprising a camera to generate said video data.

7. The apparatus of claim 1, wherein said encoding aspect of video data comprises a quantization level of said video data.

8. The apparatus of claim 1, wherein said encoding aspect of video data comprises a motion estimation range of said video data.

9. The apparatus of claim 1, wherein said video quality adjustment module is configured to associate said identified power status information with at least one group of a plurality of groups, each said group being representative of a predefined power level range of said device, and
wherein said video quality adjustment module is configured to associate a predefined characteristic of the encoding aspect with each said group.

10. A method, comprising:
receiving video data at a computing device;
receiving power status of the computing device;
determining an encoding parameter for said received video data based on said power status;
encoding said received video data using said encoding parameter; and
transmitting said encoded data for display on a display device.

11. The method of claim 10, wherein said encoding parameter comprises one of a quantization parameter and a motion estimation parameter.

12. The method of claim 10, comprising associating said power status with one of a plurality of groups, each group of said plurality of groups being representative of a predefined power level range of said computing device.

13. The method of claim 12, comprising associating a predefined value of the encoding parameter with each group of said plurality of groups.

14. The method of claim 13, wherein said predefined encoding parameter associated with each group is different than said predefined value for all other groups of said plurality of groups.

15. An article comprising a memory containing instructions that when executed by one or more processors enable a system to:
receive video data;
receive power status information for the computing device;
set at least one encoding parameter for said received video data based on said power status information; and
encode said received video data using said at least one encoding parameter.

16. The article of claim 15, comprising instructions that when executed enable the system to receive information regarding a power level of a battery of said device at a predetermined rate.

17. The article of claim 15, wherein said encoding parameter comprises one of a quantization parameter and a motion estimation parameter.

18. The article of claim 15, comprising instructions that when executed enable the system to receive information regarding a power level of a battery of said device at a user-selectable rate.

19. The article of claim 15, comprising instructions that when executed enable the system to associate said power status information with one of a plurality of groups, each group of said plurality of groups being representative of a predefined power level range of said computing device.

20. The article of claim 19, comprising instructions that when executed enable the system to associate a predefined value of the encoding parameter with each group of said plurality of groups.
